(19) United States
(12) Patent Application Publication
(10) Pub. No.: US 2026/0065021 A1
(43) Pub. Date: Mar. 5, 2026

(54) GENERATING FEATURE SETS TO INPUT TO A LARGE LANGUAGE MODEL TO OPTIMIZE A MESSAGE

(71) Applicant: INTERNATIONAL BUSINESS MACHINES CORPORATION, ARMONK, NY (US)

(72) Inventors: Jeremy Connell-Waite, Bristol (GB); Lucia Larise Stavarache, Columbus, OH (US); Jennifer M. Hatfield, Portland, OR (US); Yu YC Cai, Beijing (CN); Jesus Mantas, Austin, TX (US)

(21) Appl. No.: 18/818,040

(22) Filed: Aug. 28, 2024

(51) Int. Cl. G06N 3/0455

(52) U.S. Cl. CPC G06N 3/0455

(57) ABSTRACT

Provided are a computer program product, system, and method for generating feature sets to input to a large language model to optimize a message. A source message is inputted to a first machine learning model to determine topics in the source message. Information type preferences of the members of the target group, the topics in the source message, and skillsets of the presenters correlated with the topics in the source message are inputted to a second machine learning model to output performance scores for the presenters predicting a suitability of the presenters to deliver the source message. The source message, the topics in the source message, the skillsets of a selected presenter, having a performance score exceeding a threshold, correlated with the topics, and the information type preferences of the members of the target group are inputted to an LLM to output a target message to the target group.

### BACKGROUND OF THE INVENTION

### 1. Field of the Invention

The present invention relates to a computer program product, system, and method for generating feature sets to input to a large language model to optimize a message.

### 2. Description of the Related Art

Large language models (LLMs) may process input text to output more robust and complete output text. While LLMs are capable of generating output for a wide range of topics, they have contextual limitations in having difficulty addressing nuanced, context-specific or evolving information. Oftentimes the user of LLMs may not know how best to determine what to input to the LLM to produce optimal output given the context of the input text. Further, the user of the LLM may not have ready access to sources of information whose input to the LLM could improve the generated output. Providing limited feedback to the LLM may result in output that will not have the desired effect of boosting interactions and engagement with the output.

### SUMMARY

Provided are a computer program product, system, and method for generating feature sets to input to a large language model to optimize a message. Information on roles of members of a target group are processed to determine information type preferences for members of the target group. A source message is inputted to a first machine learning model to determine topics in the source message. Information on presenters is processed to determine skillsets of the presenters correlated with the topics in the source message. The information type preferences of the members of the target group, the topics in the source message, and the skillsets of the presenters correlated with the topics in the source message are inputted to a second machine learning model to output performance scores for the presenters predicting a suitability of the presenters to deliver the source message. Selection is made of one of the presenters having a performance score exceeding a threshold. The source message, the topics in the source message, the skillsets of the selected presenter correlated with the topics, the information type preferences of the members of the target group are inputted to an LLM to output a target message with a pitch adapted for the selected presenter to present to the members of the target group to optimize effectiveness of the target message for the members of the target group.

### BRIEF DESCRIPTION OF THE DRAWINGS

FIG. 1 illustrates an embodiment of a computing environment to generate output messages from a source message.

FIG. 2 illustrates an embodiment of a target group feature set having information on a target group to which the message is directed.

FIG. 3 illustrates an embodiment of a message feature set having information on the message to optimize with the LLM.

FIG. 4 illustrates an embodiment of a presenter feature set having information on a presenter to deliver the message to the target group.

FIG. 5 illustrates an embodiment of a training set based on an output message produced by the LLM that may be used to train the LLM.

FIG. 6 illustrates an embodiment of operations to generate a target group feature set.

FIG. 7 illustrates an embodiment of operations to generate a message feature set.

FIG. 8 an embodiment of operations to select a presenter from available presenters to deliver the message and to generate a presenter feature set.

FIG. 9 illustrates an embodiment of operations to generate the target message from the LLM and to generate a training set for the generated target message.

FIG. 10 illustrates an embodiment of operations to train the LLM from the training sets.

FIG. 11 illustrates an embodiment of operations to run a simulation to determine a presenter's suitability to deliver content to a target group type.

FIG. 12 illustrates a computing environment in which the components of FIG. 1 may be implemented.

### DETAILED DESCRIPTION

People may use an LLM to generate content to present to an audience or target group, but may not know how to fashion the input to the LLM to optimize the effectiveness of the output to their target audience. Producing less than optimal messages may result in lost opportunities and dissatisfied recipients of the message.

Described embodiments provide improvements to computer technology to use a LLM to generate an output message by generating robust feature sets based on gathered and derived information for the presenter of the message, the target group audience to receive the message, and the source message content and goals. For each of the feature sets, described embodiments gather various sources of information, on the target group to receive the message, the original message, and the presenter, and further use different machine learning models to generate specific derived information on the target group, message, and presenter, and include the gathered and derived information into feature sets to input to the LLM to generate the target output. In this way, the described embodiments generate robust input feature sets for the LLM to optimize the effectiveness of the output target message in affecting the target group based on attributes of the presenter, target group, and message. A more effective message increases interactions and engagement with the target message.

Though this disclosure pertains to the collection of data (e.g., user activity across different projects and tasks) it is noted that in embodiments, users opt into the system. In doing so, they are informed of what data is collected and how it will be used, that any collected personal data may be encrypted while being used, that the users can opt-out at any time, and that if they opt out, any personal data of the user is deleted.

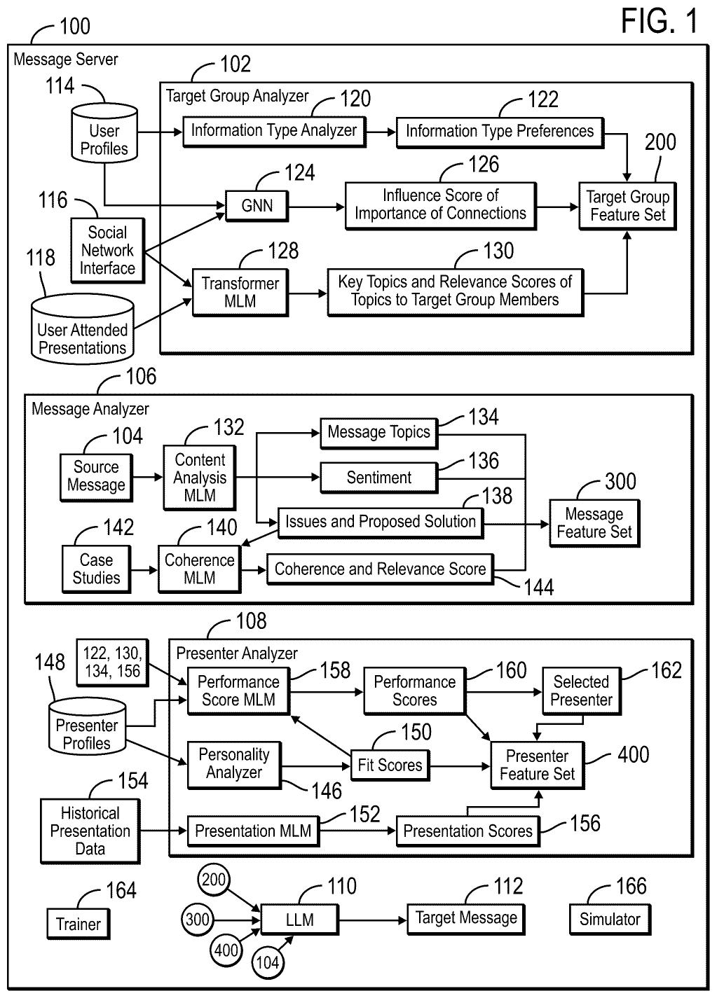

FIG. 1 illustrates an embodiment of a message server 100 to generate a message to optimize the effectiveness of the message based on available presenters, target group of members to which the message is directed, and message content. The message server 100 includes a target group analyzer 102 to generate a target group feature set 200 having features relevant to members of a target group to which a source message 104 is directed, a message analyzer 106 to generate a message feature set 300 having features relevant to content of the message, and a presenter analyzer 108 to select a presenter to present the source message 104 to the target group of members and generate a presenter feature set 400. The feature sets 200, 300, 400 and the source message 104 are inputted to a large language model (LLM) 110 to generate a target message 112 providing a modified source message 104, including changes to content and pitch, that is optimized based on attributes of the selected presenter, the members of the target group, and the source message 104. as reflected in the feature sets 200, 300, 400.

The target group analyzer 102 receives input from user profiles 114, having information on members of a target group to receive the presentation, including roles in an organization, and a social network interface 116, which gathers information on social network contacts for members of the target group, and user attended presentations 118, such as transcripts of video conferences, conferences, publications ordered, other information consumed, etc. Information on roles, such as position in organization, in the user profiles 114, is inputted to an information type analyzer 120 to generate information type preferences 122 for the members of the target group. The information type analyzer 120 may use heuristic rules or a classifier machine learning model to map target group member roles to information type preferences 122. Information on networks of social contacts for the members of the target group are gathered by the social network interface 116 interfacing with target group member accounts in a social network, such as a business, creative, or personal oriented social network.

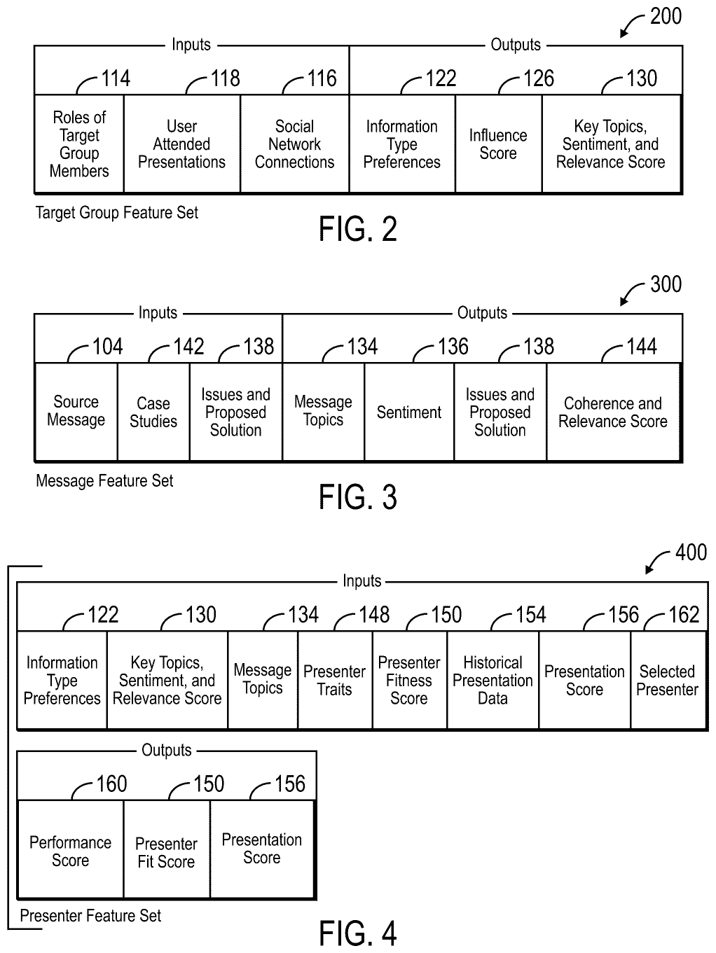

The network connection information of the group members from the social network interface 116 and information on user profiles 114 of the members of the target group are inputted to a graphical neural network (GNN) 124 to generate an influence score 126 indicating the importance of the social network connections for the members of the group, which is indicative of the influence the member of the target group has in the social network. The target group analyzer 102 may then determine topics of interest to the members of the target group by inputting user attended presentations 118 and interests gathered via the social network interface 116 from a social network into a transformer machine learning model (MLM) 128, which outputs key topics of interest to the target group members and relevance scores 130 of the relevance of the topics to the target group members. The relevance score 130 may be a value from 0 to 1 indicating relevance of a topic. The transformer MLM 128 may comprise a Bidirectional Encoder Representations from Transformers (BERT). The inputs 114, 116, 118 to the target group analyzer models 120, 124, 128 and the outputs 122, 126, and 130 may be added to the target group features set 200, as shown in FIG. 2.

A message analyzer 106 receives as input the source message 104 and inputs to a content analysis machine learning model (MLM) 132 to process the source message 104 to generate message topics 134 in the source message 104, a sentiment 136 of the source message 104, and issues and proposed solutions 138 in the source message 104. A coherence MLM 140 receives case studies 142, having information on the issues and proposed solutions 138 raised in the source message 104, such as discussed solutions or consequences of the issues, to generate a coherence and relevance score 144, such as aa value between 0 and 1, indicating a relevance of the proposed solution to the determined issues in the source message 104. The inputs 104, 142, 138 and the outputs 134, 136, 138, 144 may be added to the message feature set 300, as shown in FIG. 3.

A presenter analyzer 108 is used to select a best suited presenter to present the source message 104 to the target group members. The presenter analyzer 108 includes, or accesses, a personality analyzer 146 to receive as input personality traits of the available presenters from the presenter profiles 148, such as Myers-Briggs Type Indicator® (MBTI®) personality types, and outputs fitness scores 150 of the presenters, indicating their alignment with successful sales traits. A presentation machine learning model (MLM) 152 may receive historical presentation data 154 for the presenters, such as prior sales data or results of previous presentations, and output presentation scores 156 for the available presenters on past presentation performance. The presentation scores 156 may comprise a value from 0 to 1 indicating the efficacy of the presenters in presenting information, such as making sales pitches. The presentation MLM 152 may comprise a deep neural network (DNN). (MBTI and Myers-Briggs Type Indicator are registered trademarks owned by Myers & Briggs Foundation, Inc. in the United States and other countries).

The presenter analyzer 108 further includes, or has access to, a performance score machine learning model (MLM) 158 that receives, as input, information type preferences 122 of the group members, key topics and relevance scores 130 for the members in the target group, indicating interests of the target group members, message topics 134 in the source message 104, skillsets of the presenters in the presenter profiles 148, the fitness scores 150 of the presenters, and the presentation scores 156, to output performance scores 160 for the available presenters. The performance scores 160 may comprise a value from 0 to 1 evaluating a presenter expected ability to present the source message 104 to the members of the target group. The presenter analyzer 108 may determine presenters having a performance score 160 greater than a threshold and then select one of the determined presenters 162, which may comprise the presenter having a highest performance score.

A presenter feature set 400 may then be formed, as shown in FIG. 4, having the inputs comprising information 122, 130, 134, presenter traits 148, fitness score 150, presentation score 156, historical presentation data 154 for the selected presenter 162, and the selected presenter 162, and the outputs comprising the performance score 160, fitness score 150, and presentation score 156 of the selected presenter 162. In this way the feature sets 200, 300, 400 include all the inputs to the various machine learning models and the outputs.

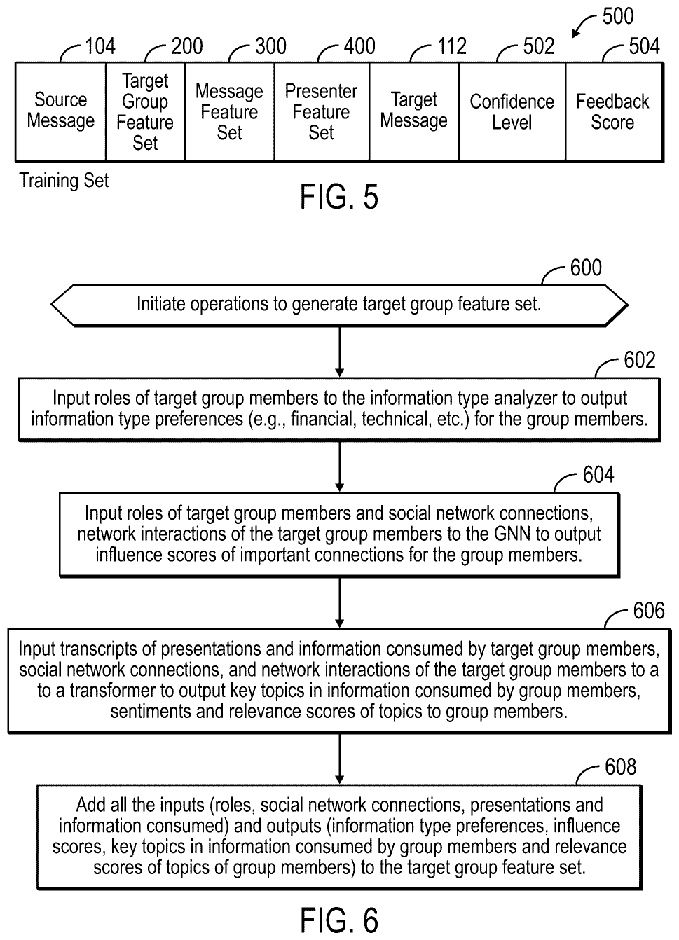

The message server 100 may further include a trainer 164 to gather training sets 500, as shown in FIG. 5, including the inputs 200, 300, 400, 104 and output 112 for the LLM 110 to then use to train the LLM 110 through backpropagation. The training set 500 may further include a confidence level 502 indicating a confidence or probability the target message 112 provides an optimal modification of the source message 104 considering the selected presenter and target group members. A confidence level, confidence interval or confidence score may comprise a number between 0 and 1, or other numerical range or fixed number of levels (e.g., high, medium or low), that represents the likelihood that the output of the LLM 110 produces optimal target message 112 for the target group, message, and presenters. The training set 500 may further include feedback 504, such as a feedback score based on a rating or score provided by the group members who have reviewed the target message 112 and indicated an extent of the effectiveness of the target message 112.

The trainer 164 may further gather training sets for other of the machine learning models 120, 124, 128, 132, 140, 146, 152, 158 to use to train those models, such as using backpropagation.

The message server 100 may further include a simulator program 166 to run simulations to allow a presenter to use past training sets 500 for a specified target group to determine input to the performance score MLM 158 to determine their performance score 160, which may be indicative of whether they are suited for making presentations to the specified target group.

The source message 104 may be in the same media format as the target message 112, such as text. Alternatively, the source message 104 may be in one media format, and the target message 112 outputted from the LLM 110 may be in another audio format, such as an audio-video format. The messages 104, 112 may be in formats such as text, audio-video, images, virtual reality renderings, etc.

The arrows shown in FIG. 1 between the components and objects represent a data flow between the components.

Generally, program modules, such as the program components 102, 106, 108, 110, 112, 120, 124, 128, 132, 140, 146, 152, 158, 164, 166, among others, may comprise routines, programs, objects, components, logic, data structures, and so on that perform particular tasks or implement particular abstract data types. The program components and hardware devices of the system 100 may be implemented in one or more computer systems, where if they are implemented in multiple computer systems, then the computer systems may communicate over a network.

The program components 102, 106, 108, 110, 112, 120, 124, 128, 132, 140, 146, 152, 158, 164, 166, among others, may be accessed by a processor from memory to execute. Alternatively, some or all of the program components 102, 106, 108, 110, 112, 120, 124, 128, 132, 140, 146, 152, 158, 164, 166, among others, may be implemented in separate hardware devices, such as Application Specific Integrated Circuit (ASIC) hardware devices. Program components implemented as machine learning models, such as program components 110, 120, 124, 128, 132, 140, 146, 152, 158, among others, may be implemented in an Artificial Intelligence (AI) hardware accelerator or inference engine.

In certain embodiments, program components 110, 120, 124, 128, 132, 140, 146, 152, 158, among others, may use machine learning and deep learning algorithms, such as decision tree learning, association rule learning, neural network, inductive programming logic, support vector machines, Bayesian network, Recurrent Neural Networks (RNN), Feedforward Neural Networks, Convolutional Neural Networks (CNN), Deep Convolutional Neural Networks (DCNNs), Generative Adversarial Network (GAN), etc. For artificial neural network program implementations, the neural network may be trained using backward propagation to adjust weights and biases at nodes in a hidden layer to produce their output based on the received inputs which may comprise the inputs received during operations by the machine learning models 110, 120, 124, 128, 132, 140, 146, 152, 158. In backward propagation used to train a neural network machine learning module, biases at nodes in the hidden layer are adjusted accordingly to produce the desired output based on the received inputs which may comprise the inputs received during operations by the machine learning models 110, 120, 124, 128, 132, 140, 146, 152, 158. Backward propagation may comprise an algorithm for supervised learning of artificial neural networks using gradient descent. Given an artificial neural network and an error function, the method may use gradient descent to find the parameters (coefficients) for the nodes in a neural network or function that minimizes a cost function measuring the difference or error between actual and predicted values for different parameters. The parameters are continually adjusted during gradient descent to minimize the error. In backward propagation used to train a neural network machine learning module, such as the 110, 120, 124, 128, 132, 140, 146, 152, 158, margin of errors are determined based on a difference of the calculated predictions and user rankings of the output. Biases (parameters) at nodes in the hidden layer are adjusted accordingly to minimize the margin of error of the error function.

In an alternative embodiment, the components 110, 120, 124, 128, 132, 140, 146, 152, 158, may be implemented not as a machine learning module, but implemented using a rules based system to determine the outputs from the inputs. The components 110, 120, 124, 128, 132, 140, 146, 152, 158 may further be implemented using an unsupervised machine learning module, or machine learning implemented in methods other than neural networks, such as multivariable linear regression models.

The functions described as performed by the program components 102, 106, 108, 110, 112, 120, 124, 128, 132, 140, 146, 152, 158, 164, 166, among others, may be implemented as program code in fewer program modules than shown or implemented as program code throughout a greater number of program modules than shown.

The functions performed by the machine learning models 110, 120, 124, 128, 132, 140, 146, 152, 158 may be implemented in only one, fewer or more machine learning models than shown in FIG. 1.

The message server 100 may comprise a server, virtual machine, cloud computing system, or a personal computing device, such as a laptop, desktop computer, tablet, smartphone, wearable computer, augmented reality glasses, etc.

In certain embodiments, the target message 112 being generated may comprise news to deliver in a business setting, such as a sales pitch, delivery of key business news, presentation of new developments, educational training, other organizational plans, storytelling, a script, a book, a movie or show, etc. The presenters may comprise members of the organization or company presenting the message, such as sales people, executive management. The target message 112 may be delivered in different media, such as a speech, video presentation, slide show, written communication, etc. The target group may comprise potential purchasers, potential investors, government officials, employees of the organization, etc. The described embodiments may extend to other environments, where the message 112 to deliver may comprise a legal argument, the presenter attorneys, and the target group a judge or jury. The message 104, 112 may comprise any type of storyline, e.g., entertainment, political speech, educational lesson, the presenter someone delivering the storyline, e.g., actor, politician, educator, and the target group the intended recipient, e.g., audience, spectators, students, etc.

FIG. 6 illustrates an embodiment of operations performed by the target group analyzer 102 to generate the target group feature set 200 for the LLM 119 to provide relevant information for the target group of members to which the message is directed. Upon initiating (at block 600) operations to generate a target group feature set 200, the target group analyzer 102 inputs (at block 602) roles of target group members from the user profiles 114 to the information type analyzer 120 to output information type preferences 122 (e.g., financial, technical, etc.) for the group members. The target group analyzer 102 inputs (at block 604) roles of the target group members in the user profiles 114, such as job, affiliations, education background, etc., and social network connections and network interactions of the target group members, obtained from a social network, such as a business social network, through the social network interface 116, to the GNN 124 to output influence scores 126 of the important of the connections for the group members. The target group analyzer 102 further inputs (at block 606) transcripts of user attended presentations 118, including other information consumed by target group members, and social network connections from the social network interface 116, to a transformer MLM 128 to output key topics of information consumed by group members, sentiments, and relevance scores of the topics to the group members 130. All the inputs (roles 114, social network connections 116, presentations and information consumed 118) and outputs (information type preferences 122, influence scores 126, key topics and relevance scores 130 of topics of group members) are added (at block 608) to the target group feature set 200.

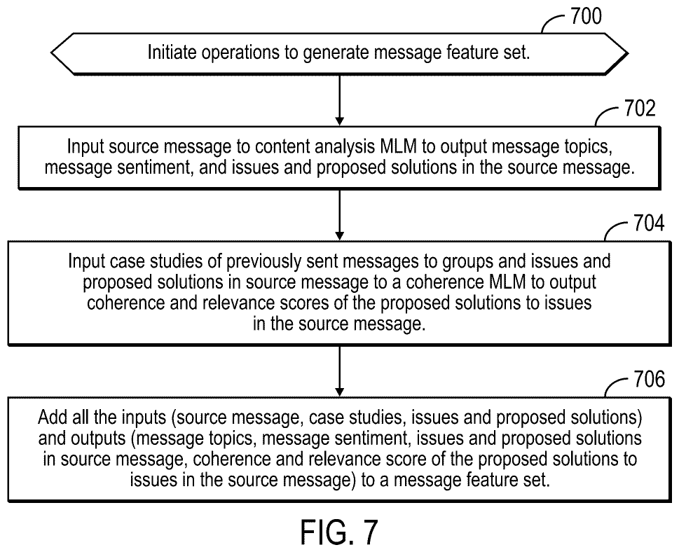

FIG. 7 illustrates an embodiment of operations performed by the message analyzer 106 to generate the message feature set 300. Upon initiating (at block 700) operations to generate the message feature set 300, the message analyzer 106 inputs (at block 702) the source message 104 to the content analysis MLM 132 to output message topics 134, message sentiment 136, and issues and proposed solutions 138 in the source message 104. The message analyzer 106 inputs (at block 704) case studies 142, of previously sent messages to groups, and the issues and proposed solutions 138 in the source message 104, to a coherence MLM 140 to output a coherence and relevance score 144 of the proposed solutions to issues in the source message 104. All the inputs (source message 104, case studies 142, issues and proposed solutions 138) and outputs (message topics 134, message sentiment 136, issues and proposed solutions 138 in source message, coherence and relevance score 144 of the proposed solutions to issues in the source message 104) are added to a message feature set 300.

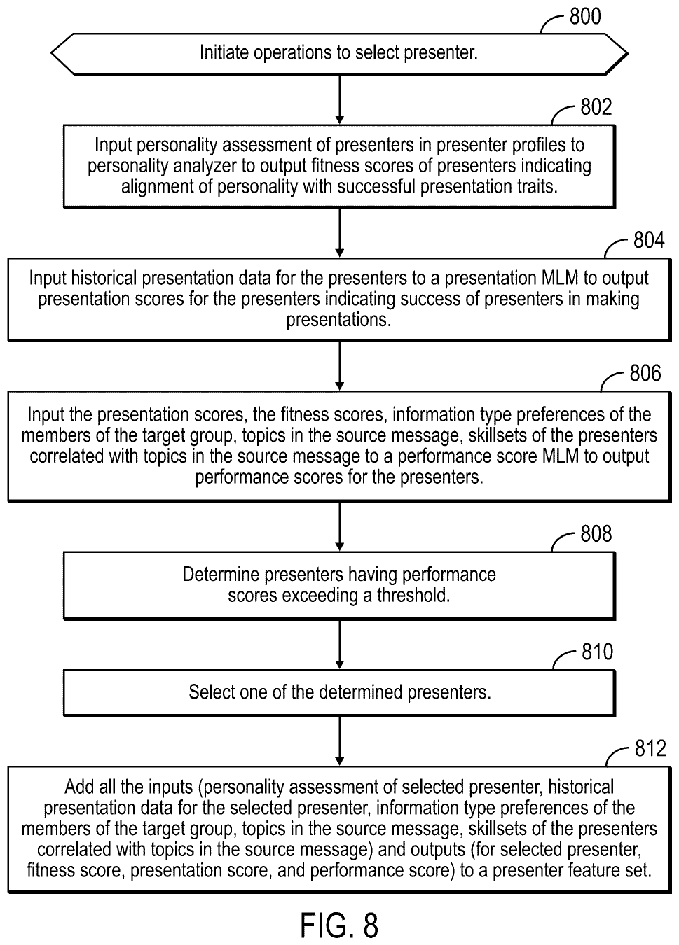

FIG. 8 illustrates an embodiment of operations performed by the presenter analyzer 108 to select a presenter to deliver the target message 112 and to generate the presenter feature set 400. Upon initiating (at block 800) operations to select a presenter from available presenters, the presenter analyzer 108 inputs (at block 802) a personality assessment of presenters in the presenter profiles 148, such as an MBTI® assessment, to the personality analyzer 146 to output fitness scores 150 of the potential presenters indicating alignment of personalities with successful presentation traits. The presenter analyzer 108 inputs (at block 804) historical presentation data 154 for the presenters to a presentation MLM 152 to output presentation scores 156 for the presenters indicating success of presenters in making past presentations, e.g., sales, favorable reviews, repeat attendees, etc. The presentation analyzer 108 inputs (at block 806) the presentation scores 156, the fitness scores 150, information type preferences 122 of the members of the target group, topics 134 in the source message, skillsets of the presenters, from the presenter profiles 148 correlated with the message topics 134 in the source message 104 to a performance score MLM 158 to output performance scores 160 for the potential presenters.

The presenter analyzer 108 determines (at block 808) presenters having performance scores 160 exceeding a threshold, such as greater than 60%, indicating their ability to perform given the target group and message content. The presenter analyzer 108 then selects (at block 810) one of the determined presenters, which selection may be the presenter with the highest performance score or satisfying some other criteria. The presenter analyzer 108 adds (at block 812) all the inputs (personality assessment of selected presenter 148, historical presentation data 154 for the selected presenter, information type preferences 122 of the members of the target group, topics 134 in the source message, skillsets of the presenters 148 correlated with topics 134 in the source message 104) and outputs (for selected presenter, fitness score 150, presentation score 156, and performance score 160) to a presenter feature set 400.

With the embodiments of FIGS. 6, 7, and 8, feature sets 200, 300, 400 to input to the LLM 110 are supplemented with not only data for the selected presenter, target group, and source message 104, but also derived information, derived through processing by various machine learning models, e.g., 120, 124, 128, 132, 140, 158, 146, 152, to provide robust input to the LLM 110 to tailor the source message 104 to the target group to receive the message and to the abilities of the best suited presenter to deliver the message.

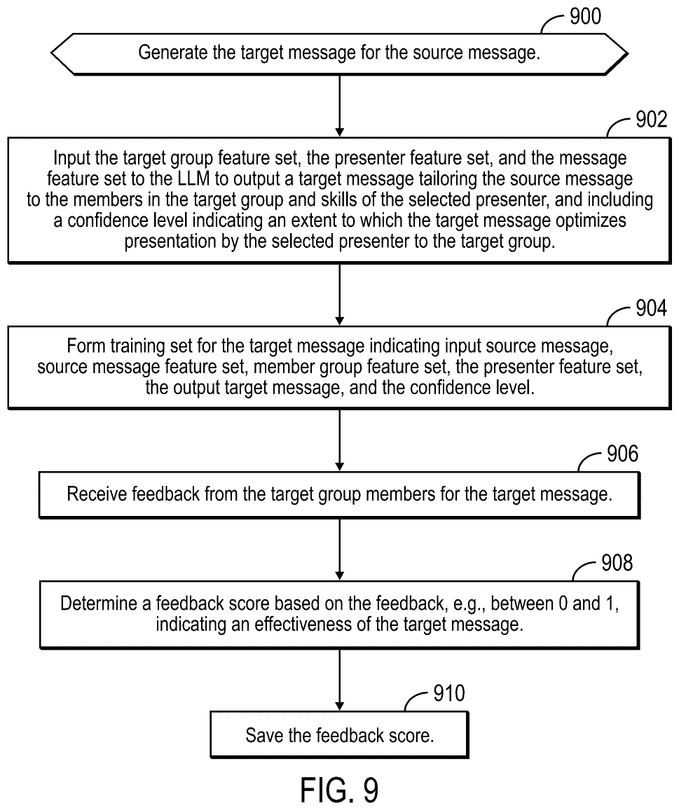

FIG. 9 illustrates an embodiment of operations performed by the LLM 110 to generate the target message 112 and the trainer program 164 to generate a training set 500 for the LLM 110. Upon initiating (at block 900) operations to generate the target message 112 for the source message 104, the source message feature set 200, member group feature set 300, the presenter feature set 400, and the source message 104 are inputted (at block 902) to the LLM 110 to output the target message 112 tailored to the members in the target group and skills of the selected presenter, and including a confidence level 502 indicating an extent to which the target message 112 optimizes presentation by the selected presenter to the target group. The trainer program 164 may then form (at block 904) a training set 500 for the target message 112 indicating, input source message 104, target group feature set 200, message feature set 300, presenter features set 400, the target message 112, the confidence level 502 associated with the target message 112.

The trainer program 164 receives (at block 906) feedback from the target group members for the target message 112. The trainer program 164 determines (at block 908) a feedback score 504 based on the feedback, e.g., between 0 and 1, indicating an effectiveness of the target message 112. The feedback score 504 is saved in the training set 500 for the target message 112.

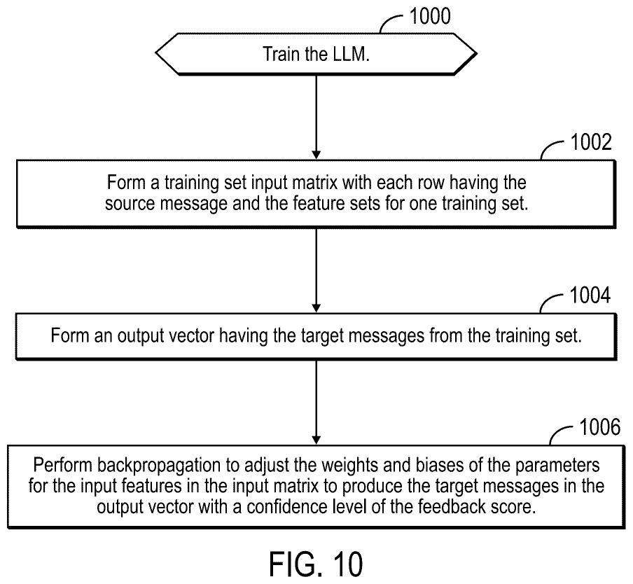

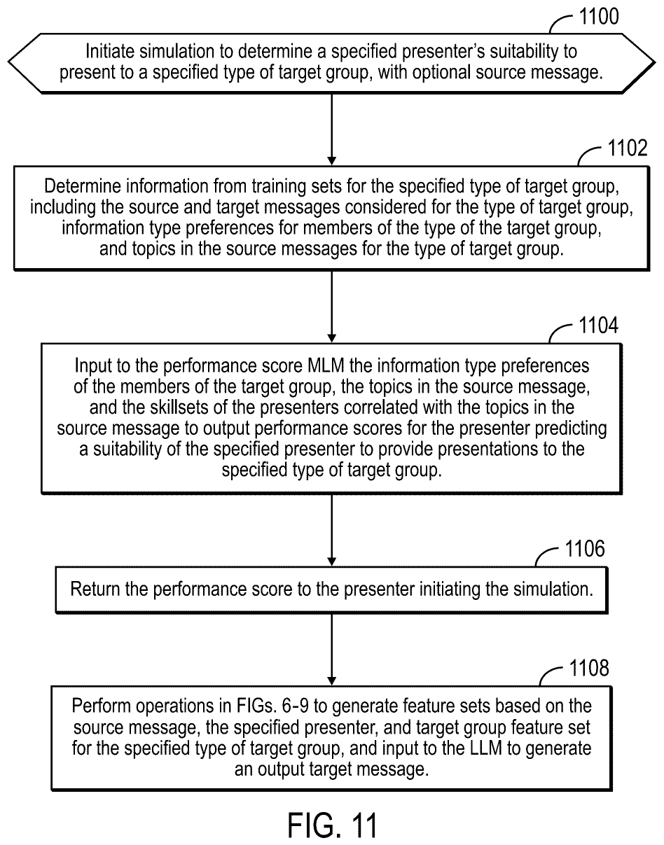

FIG. 10 illustrates an embodiment of operations performed by the trainer program 164 to train the LLM 110 from training sets 500 generated for different target messages 112 generated from source messages 104. Upon initiating (at block 1000) an operation to train the LLM 110, the trainer program 164 forms (at block 1002) a training set input matrix with each row having the source message 104 and the feature sets 200, 300, 400 for one training set 500. An output vector is formed (at block 1004) having the target messages 112 from the training sets 500. The trainer program 164 performs (at block 1006) backpropagation to adjust the weights and biases of the parameters for the input features 200, 300, 400 in the input matrix to produce the target messages 112 in the output vector with a confidence level of the feedback score 504.

With the embodiment of FIG. 10, the weights and biases of the parameters in LLM 110 are adjusted to output a target message 112 having a confidence level corresponding to the feedback score 504, between 0 and 1, indicating the confidence level with which the target message 112 will meet with approval by the target group receiving the target message 112. In this way, the LLM 110 is trained to output target messages 112 in accordance with the feedback scores the target group members provide for the received target messages 112.

In alternative embodiments, the training may involve providing ground truth target messages for a source message that are deemed to be the optimal target message given the selected presenter and target group. The training program 164 may then use backpropagation to train the LLM 110 to output the ground truth target messages from the source messages 104 and feature sets 200, 300, 400 used as input.

FIG. 11 illustrates an embodiment of operations performed by the simulator program 166 to run a simulation to determine the performance score 160 for a presenter with respect to a specified target group. This simulated performance score 160 allows the presenter to learn about their suitability to make presentations to the specified target group. Upon initiating (at block 1100) a simulation to determine a specified presenter's suitability to present to a specified type of target group, with an optional source message, the simulator program 166 may determine (at block 1102) information from previous training sets 500 for the specified type of target group, including the source 104 and target 112 messages considered for the type of target group, information type preferences 122 for members of the type of the target group, and topics 134 in the source messages 104 for the type of target group. The simulator program 166 may then input (at block 1104) the information type preferences 122 of the members of the target group, the topics 134 in the source message, and the skillsets 148 of the presenters correlated with the topics in the source message to the performance score MLM 158 to output a performance score 160 for the specified presenter running the simulation, predicting a suitability of the specified presenter to provide presentations to the specified type of target group. The performance score 160 may then be returned (at block 1106) to the presenter for consideration.

Further, if the presenter provides a message they would like to have optimized for presentation for their skills and for the specified type of target group, then the simulator program 166 may perform (at block 1108) operations in FIGS. 6-9 to generate feature sets based on the provided source message, the specified presenter, and target group feature set for the specified type of target group, and input to the LLM 110 to generate an output target message 112.

With the operations of FIG. 11, a presenter may use the system to obtain information on their suitability to deliver messages to a specified type of target group, e.g., a specific professional group, a group of clients, a group of executives, etc. The presenter may then use this information of the performance score 160 to determine if their duties should be expanded to cover presentations to the specified type of target group. Moreover, the presenter may generate sample target messages to see how messages they prepare would be modified for consideration by the specified target group.

The present invention may be a system, a method, and/or a computer program product. The computer program product may include a computer-readable storage medium (or media) having computer-readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

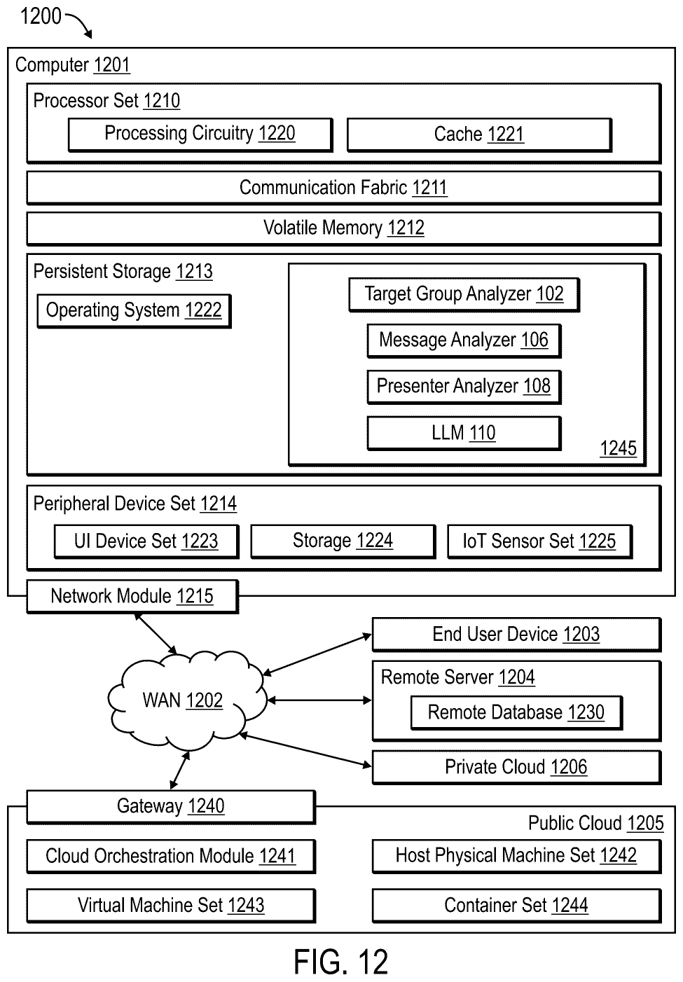

With respect to FIG. 12, computing environment 1200 contains an example of an environment for the execution of at least some of the computer code involved in performing the inventive methods, such as to generate the feature sets and information to input to an LLM to modify a source message to optimize for a particular target group to receive the message and a presenter of the message in the components of block 1245, including the target group analyzer 102, message analyzer 106, presenter analyzer 108, and the LLM 110 to optimize the message. In addition to block 1245, computing environment 1200 includes, for example, computer 1201, wide area network (WAN) 1202, end user device (EUD) 1203, remote server 1204, public cloud 1205, and private cloud 1206. In this embodiment, computer 1201 includes processor set 1210 (including processing circuitry 1220 and cache 1221), communication fabric 1211, volatile memory 1212, persistent storage 1213 (including operating system 1222 and block 1245, as identified above), peripheral device set 1214 (including user interface (UI) device set 1223, storage 1224, and Internet of Things (IoT) sensor set 1225), and network module 1215. Remote server 1204 includes remote database 1230. Public cloud 1205 includes gateway 1240, cloud orchestration module 1241, host physical machine set 1242, virtual machine set 1243, and container set 1244.

COMPUTER 1201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1230. As is well understood in the art of computer technology, and depending upon the technology, performance of a computer-implemented method may be distributed among multiple computers and/or between multiple locations. On the other hand, in this presentation of computing environment 1200, detailed discussion is focused on a single computer, specifically computer 1201, to keep the presentation as simple as possible. Computer 1201 may be located in a cloud, even though it is not shown in a cloud in FIG. 12. On the other hand, computer 1201 is not required to be in a cloud except to any extent as may be affirmatively indicated.

PROCESSOR SET 1210 includes one, or more, computer processors of any type now known or to be developed in the future. Processing circuitry 1220 may be distributed over multiple packages, for example, multiple, coordinated integrated circuit chips. Processing circuitry 1220 may implement multiple processor threads and/or multiple processor cores. Cache 1221 is memory that is located in the processor chip package(s) and is typically used for data or code that should be available for rapid access by the threads or cores running on processor set 1210. Cache memories are typically organized into multiple levels depending upon relative proximity to the processing circuitry. Alternatively, some, or all, of the cache for the processor set may be located “off chip.” In some computing environments, processor set 1210 may be designed for working with qubits and performing quantum computing.

Computer-readable program instructions are typically loaded onto computer 1201 to cause a series of operational steps to be performed by processor set 1210 of computer 1201 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 1221 and the other storage media discussed below. The program instructions, and associated data, are accessed by processor set 1210 to control and direct performance of the inventive methods. In computing environment 1200, at least some of the instructions for performing the inventive methods may be stored in block 1245 in persistent storage 1213.

COMMUNICATION FABRIC 1211 is the signal conduction path that allows the various components of computer 1201 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 1212 is any type of volatile memory now known or to be developed in the future. Examples include dynamic type random access memory (RAM) or static type RAM. Typically, volatile memory 1212 is characterized by random access, but this is not required unless affirmatively indicated. In computer 1201, the volatile memory 1212 is located in a single package and is internal to computer 1201, but, alternatively or additionally, the volatile memory may be distributed over multiple packages and/or located externally with respect to computer 1201.

PERSISTENT STORAGE 1213 is any form of non-volatile storage for computers that is now known or to be developed in the future. The non-volatility of this storage means that the stored data is maintained regardless of whether power is being supplied to computer 1201 and/or directly to persistent storage 1213. Persistent storage 1213 may be a read only memory (ROM), but typically at least a portion of the persistent storage allows writing of data, deletion of data and re-writing of data. Some familiar forms of persistent storage include magnetic disks and solid state storage devices. Operating system 1222 may take several forms, such as various known proprietary operating systems or open source Portable Operating System Interface-type operating systems that employ a kernel. The code included in block 1245 typically includes at least some of the computer code involved in performing the inventive methods.

PERIPHERAL DEVICE SET 1214 includes the set of peripheral devices of computer 1201. Data communication connections between the peripheral devices and the other components of computer 1201 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1223 may include components such as a display screen, speaker, microphone, wearable devices (such as goggles and smart watches), keyboard, mouse, printer, touchpad, game controllers, and haptic devices. Storage 1224 is external storage, such as an external hard drive, or insertable storage, such as an SD card. Storage 1224 may be persistent and/or volatile. In some embodiments, storage 1224 may take the form of a quantum computing storage device for storing data in the form of qubits. In embodiments where computer 1201 is required to have a large amount of storage (for example, where computer 1201 locally stores and manages a large database) then this storage may be provided by peripheral storage devices designed for storing very large amounts of data, such as a storage area network (SAN) that is shared by multiple, geographically distributed computers. IoT sensor set 1225 is made up of sensors that can be used in Internet of Things applications. For example, one sensor may be a thermometer and another sensor may be a motion detector.

NETWORK MODULE 1215 is the collection of computer software, hardware, and firmware that allows computer 1201 to communicate with other computers through WAN 1202. Network module 1215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1215 are performed on the same physical hardware device. In other embodiments (for example, embodiments that utilize software-defined networking (SDN)), the control functions and the forwarding functions of network module 1215 are performed on physically separate devices, such that the control functions manage several different network hardware devices. Computer-readable program instructions for performing the inventive methods can typically be downloaded to computer 1201 from an external computer or external storage device through a network adapter card or network interface included in network module 1215.

WAN 1202 is any wide area network (for example, the internet) capable of communicating computer data over non-local distances by any technology for communicating computer data, now known or to be developed in the future. In some embodiments, the WAN 1202 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1203 is any computer system that is used and controlled by an end user (for example, a customer of an enterprise that operates computer 1201), and may take any of the forms discussed above in connection with computer 1201. EUD 1203 typically receives helpful and useful data from the operations of computer 1201. For example, in a hypothetical case where computer 1201 is designed to provide a recommendation to an end user, this recommendation would typically be communicated from network module 1215 of computer 1201 through WAN 1202 to EUD 1203. In this way, EUD 1203 can display, or otherwise present, the recommendation to an end user. In some embodiments, EUD 1203 may be a client device, such as thin client, heavy client, mainframe computer, desktop computer and so on.

REMOTE SERVER 1204 is any computer system that serves at least some data and/or functionality to computer 1201. Remote server 1204 may be controlled and used by the same entity that operates computer 1201. Remote server 1204 represents the machine(s) that collect and store helpful and useful data for use by other computers, such as computer 1201. For example, in a hypothetical case where computer 1201 is designed and programmed to provide a recommendation based on historical data, then this historical data may be provided to computer 1201 from remote database 1230 of remote server 1204.

PUBLIC CLOUD 1205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1205 is performed by the computer hardware and/or software of cloud orchestration module 1241. The computing resources provided by public cloud 1205 are typically implemented by virtual computing environments that run on various computers making up the computers of host physical machine set 1242, which is the universe of physical computers in and/or available to public cloud 1205. The virtual computing environments (VCEs) typically take the form of virtual machines from virtual machine set 1243 and/or containers from container set 1244. It is understood that these VCEs may be stored as images and may be transferred among and between the various physical machine hosts, either as images or after instantiation of the VCE. Cloud orchestration module 1241 manages the transfer and storage of images, deploys new instantiations of VCEs and manages active instantiations of VCE deployments. Gateway 1240 is the collection of computer software, hardware, and firmware that allows public cloud 1205 to communicate through WAN 1202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1206 is similar to public cloud 1205, except that the computing resources are only available for use by a single enterprise. While private cloud 1206 is depicted as being in communication with WAN 1202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1205 and private cloud 1206 are both part of a larger hybrid cloud.

CLOUD COMPUTING SERVICES AND/OR MICROSERVICES (not separately shown in FIG. 12): private and public clouds 1206 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer program product for inputting content into a large language model (LLM) to generate a target message, the computer program product comprising a computer readable storage medium having computer readable program code embodied therein that is executable to perform operations, the operations comprising:
processing information on roles of members of a target group to determine information type preferences for members of the target group;
inputting a source message to a first machine learning model to determine topics in the source message;
processing information on presenters to determine skillsets of the presenters correlated with the topics in the source message;
inputting the information type preferences of the members of the target group, the topics in the source message, and the skillsets of the presenters correlated with the topics in the source message to a second machine learning model to output performance scores for the presenters predicting a suitability of the presenters to deliver the source message;
selecting one of the presenters having a performance score exceeding a threshold; and
inputting, to the LLM, the source message, the topics in the source message, the skillsets of the selected presenter correlated with the topics, the information type preferences of the members of the target group, to output a target message with a pitch adapted for the selected presenter to present to the members of the target group to optimize effectiveness of the target message for the members of the target group.

2. The computer program product of claim 1, wherein the operations further comprise:
inputting transcripts of content presented to members of a target group and background information on the members of the target group to a third machine learning model to output, for the topics in the source message, relevance scores indicating an alignment of interests of the members of the target group with the topics of the source message; and
inputting a source message to a fourth machine learning model, to output a sentiment score of the source message, wherein the input to the LLM to output the target message further includes the sentiment score of the source message and the relevance scores to generate the target message.

3. The computer program product of claim 1, wherein the operations further comprise:
generating a first feature set including the roles of the members in the target group, the topics in the source message, and the information type preferences of the members in the group;
generating a second feature set including skillsets of the selected presenter correlated with the topics in the source message, the performance score, of the selected presenter and the topics in the source message; and
generating a third feature set including the source message and the topics in the source message, wherein the inputting to the LLM the source message comprises inputting the first feature set, the second feature set, and the third feature set to the LLM to produce the target message.

4. The computer program product of claim 1, wherein the operations further comprise:
processing social network profiles for the members in the target group to determine information on a network of people with which they are connected; and
inputting the information on the network of people and the members of the target group to a graphical neural network to generate influence scores for the members of the target group indicating importance of connections for the members, wherein input to the LLM further includes the influence scores for the members of the target group.

5. The computer program product of claim 1, wherein the operations further comprise:
determining personality scores for the presenters based on their personality traits; and
processing the personality scores to determine, for the presenters, fitness scores indicating alignment of the personality scores with successful presentation skills; and
processing historical presentation data to determine presentation scores of the presenters indicating success of past presentations, wherein input to the second machine learning model includes the presentation sores and the fitness scores in outputting the performance scores.

6. The computer program product of claim 1, wherein the operations further comprise:
inputting the source message to a third machine learning model to determine an issue addressed by the source message and a proposed solution to the issue; and
inputting case studies or previously sent messages and issues and proposed solutions in the source message to a fourth machine learning model to output a coherence and relevance score of the source message indicating the coherence and relevance of the proposed solution to the issue, wherein input to the LLM includes the coherence and relevance score for the source message.

7. The computer program product of claim 1, wherein the operations further comprise:
receiving a request to run a simulation for a specified presenter for a type of target group;
determining historical information for the type of target group, including source messages and target messages considered for the type of target group, information type preferences for members of the type of the target group, and topics in the source messages for the type of target group;
determining a skillset of the specified presenter correlated with the topics in the source messages for the type of the target group; and
inputting the determined historical information, including the source messages and the target messages considered for the type of target group, the information type preferences for the members of the type of target group, topics in the source messages for the type of target group to the second machine learning model to output a performance score indicating suitability of the specified presenter for the type of target group; and
outputting the performance score indicating a suitability of the specified presenter for the type of target group.

8. The computer program product of claim 1, wherein the operations further comprise:
in response to feedback from the members of the target group, generating a feedback score indicating an effectiveness of a presentation of the target message by the selected presenter;
generating a training set for the source message, including input comprising the source message, the topics in the source message, the skillsets of the selected presenter correlated with the topics, the information type preferences of the members of the group, the performance score for the selected presenter, output comprising the target message, and the feedback score; and
performing backpropagation to train the LLM to output the target message in the training set from the input in the training set with a confidence level comprising the feedback score.

9. A system inputting content into a large language model (LLM) to generate a target message, comprising:
a first machine learning model;
a second machine learning model;
a processor; and
a computer readable storage medium having computer readable program code embodied therein that when executed by the processor performs operations, the operations comprising:
processing information on roles of members of a target group to determine information type preferences for members of the target group;
inputting a source message to the first machine learning model to determine topics in the source message;
processing information on presenters to determine skillsets of the presenters correlated with the topics in the source message;
inputting the information type preferences of the members of the target group, the topics in the source message, and the skillsets of the presenters correlated with the topics in the source message to the second machine learning model to output performance scores for the presenters predicting a suitability of the presenters to deliver the source message;
selecting one of the presenters having a performance score exceeding a threshold; and
inputting, to the LLM, the source message, the topics in the source message, the skillsets of the selected presenter correlated with the topics, the information type preferences of the members of the target group, to output a target message with a pitch adapted for the selected presenter to present to the members of the target group to optimize effectiveness of the target message for the members of the target group.

10. The system of claim 9, further comprising:
a third machine learning model;
a fourth machine learning model,
wherein the operations further comprise:
inputting transcripts of content presented to members of a target group and background information on the members of the target group to the third machine learning model to output, for the topics in the source message, relevance scores indicating an alignment of interests of the members of the target group with the topics of the source message; and
inputting a source message to the fourth machine learning model, to output a sentiment score of the source message, wherein the input to the LLM to output the target message further includes the sentiment score of the source message and the relevance scores to generate the target message.

11. The system of claim 9, further comprising:
generating a first feature set including the roles of the members in the target group, the topics in the source message, and the information type preferences of the members in the group;
generating a second feature set including skillsets of the selected presenter correlated with the topics in the source message, the performance score, of the selected presenter and the topics in the source message; and
generating a third feature set including the source message and the topics in the source message, wherein the inputting to the LLM the source message comprises inputting the first feature set, the second feature set, and the third feature set to the LLM to produce the target message.

12. The system of claim 9, further comprising:
a graphical neural network,
wherein the operations further comprise:
processing social network profiles for the members in the target group to determine information on a network of people with which they are connected; and
inputting the information on the network of people and the members of the target group to the graphical neural network to generate influence scores for the members of the target group indicating importance of connections for the members, wherein input to the LLM further includes the influence scores for the members of the target group.

13. The system of claim 9, wherein the operations further comprise:
receiving a request to run a simulation for a specified presenter for a type of target group;
determining historical information for the type of target group, including source messages and target messages considered for the type of target group, information type preferences for members of the type of the target group, and topics in the source messages for the type of target group;
determining a skillset of the specified presenter correlated with the topics in the source messages for the type of the target group; and
inputting the determined historical information, including the source messages and the target messages considered for the type of target group, the information type preferences for the members of the type of target group, topics in the source messages for the type of target group to the second machine learning model to output a performance score indicating suitability of the specified presenter for the type of target group; and
outputting the performance score indicating a suitability of the specified presenter for the type of target group.

14. The system of claim 9, wherein the operations further comprise:
in response to feedback from the members of the target group, generating a feedback score indicating an effectiveness of a presentation of the target message by the selected presenter;
generating a training set for the source message, including input comprising the source message, the topics in the source message, the skillsets of the selected presenter correlated with the topics, the information type preferences of the members of the group, the performance score for the selected presenter, output comprising the target message, and the feedback score; and
performing backpropagation to train the LLM to output the target message in the training set from the input in the training set with a confidence level comprising the feedback score.

15. A computer implemented method for inputting content into a large language model (LLM) to generate a target message, comprising:
processing information on roles of members of a target group to determine information type preferences for members of the target group;
inputting a source message to a first machine learning model to determine topics in the source message;
processing information on presenters to determine skillsets of the presenters correlated with the topics in the source message;
inputting the information type preferences of the members of the target group, the topics in the source message, and the skillsets of the presenters correlated with the topics in the source message to a second machine learning model to output performance scores for the presenters predicting a suitability of the presenters to deliver the source message;
selecting one of the presenters having a performance score exceeding a threshold; and
inputting, to the LLM, the source message, the topics in the source message, the skillsets of the selected presenter correlated with the topics, the information type preferences of the members of the target group, to output a target message with a pitch adapted for the selected presenter to present to the members of the target group to optimize effectiveness of the target message for the members of the target group.

16. The method of claim 15, further comprising:
inputting transcripts of content presented to members of a target group and background information on the members of the target group to a third machine learning model to output, for the topics in the source message, relevance scores indicating an alignment of interests of the members of the target group with the topics of the source message; and
inputting a source message to a fourth machine learning model, to output a sentiment score of the source message, wherein the input to the LLM to output the target message further includes the sentiment score of the source message and the relevance scores to generate the target message.

17. The method of claim 15, further comprising:
generating a first feature set including the roles of the members in the target group, the topics in the source message, and the information type preferences of the members in the group;
generating a second feature set including skillsets of the selected presenter correlated with the topics in the source message, the performance score, of the selected presenter and the topics in the source message; and
generating a third feature set including the source message and the topics in the source message, wherein the inputting to the LLM the source message comprises inputting the first feature set, the second feature set, and the third feature set to the LLM to produce the target message.

18. The method of claim 15, further comprising:
processing social network profiles for the members in the target group to determine information on a network of people with which they are connected; and
inputting the information on the network of people and the members of the target group to a graphical neural network to generate influence scores for the members of the target group indicating importance of connections for the members, wherein input to the LLM further includes the influence scores for the members of the target group.

19. The method of claim 15, further comprising:
receiving a request to run a simulation for a specified presenter for a type of target group;
determining historical information for the type of target group, including source messages and target messages considered for the type of target group, information type preferences for members of the type of the target group, and topics in the source messages for the type of target group;
determining a skillset of the specified presenter correlated with the topics in the source messages for the type of the target group; and
inputting the determined historical information, including the source messages and the target messages considered for the type of target group, the information type preferences for the members of the type of target group, topics in the source messages for the type of target group to the second machine learning model to output a performance score indicating suitability of the specified presenter for the type of target group; and
outputting the performance score indicating a suitability of the specified presenter for the type of target group.

20. The method of claim 15, further comprising:
in response to feedback from the members of the target group, generating a feedback score indicating an effectiveness of a presentation of the target message by the selected presenter;
generating a training set for the source message, including input comprising the source message, the topics in the source message, the skillsets of the selected presenter correlated with the topics, the information type preferences of the members of the group, the performance score for the selected presenter, output comprising the target message, and the feedback score; and
performing backpropagation to train the LLM to output the target message in the training set from the input in the training set with a confidence level comprising the feedback score.
